(19) United States
(12) Patent Application Publication
(10) Pub. No.: US 2018/0057348 A1
(43) Pub. Date: Mar. 1, 2018

(54) REFUELING SYSTEM AND METHOD

(71) Applicant: AFD Petroleum Ltd.,, Edmonton (CA)

(72) Inventor: Shayne LOWRIE, Edmonton (CA)

(73) Assignee: AFD Petroleum Ltd.,, Edmonton (CA)

(21) Appl. No.: 15/684,781

(22) Filed: Aug. 23, 2017

Related U.S. Application Data
(60) Provisional application No. 62/378,394, filed on Aug. 23, 2016.

(51) Int. Cl. B67D 7/36; B67D 7/04; B67D 7/30; B67D 7/32

(52) U.S. Cl. CPC B67D 7/365; B67D 7/04; B67D 7/16; B67D 7/3218; B67D 7/301

(57) ABSTRACT

There is disclosed a refueling system and method for simultaneously refueling the fuel tanks of multiple pieces of machinery in the field. In an embodiment, the system comprises a mobile tanker with at least one fuel supply tank configured to connect and supply a plurality of refueling hoses. Each refueling hose has an upstream end connected to a supply line from the at least one fuel supply tank. At a downstream end, each refueling hose terminates at a mechanical open-close valve which is adapted to be inserted within each receiving fuel tank being refueled. The mechanical open-close valve is suitably shaped and sized to provide a clearance fit within the neck diameter of each receiving fuel tank being refueled, and has a buoyant body for mechanically actuating the mechanical open-close valve.

### RELATED CASES

This application claims the benefit of U.S. Provisional Application No. 62/378,394 filed on 23 Aug. 2016, the contents of which are incorporated herein by reference.

### FIELD OF THE INVENTION

The present invention relates generally to refueling systems and methods.

### BACKGROUND

Various types of machinery used at worksites need to be operated continuously over an extended period of time. Where the machinery is powered by a combustible engine with fuel supplied from a fuel tank with limited capacity, it may be necessary to refuel the machinery's fuel tank even during the machinery's continued operation in order to prevent the fuel tank from running empty. Where worksites have multiple pieces of machinery running simultaneously, multiple fuel tanks may require refueling at the same time.

While various refueling systems and methods have been proposed, these prior art systems and methods may have unnecessary complexity, and therefore unnecessary costs for hardware and implementation. What is therefore needed is an improved system and method for refueling machinery in the field which overcomes at least some of the limitations in the prior art.

### SUMMARY

The present disclosure describes a refueling system and method for simultaneously refueling the fuel tanks of multiple pieces of machinery in the field.

In an embodiment, the system comprises a mobile tanker with at least one fuel supply tank configured to connect and supply a plurality of refueling hoses. Each refueling hose has an upstream end connected to a supply line from the at least one supply fuel tank. At a downstream end, each refueling hose is connected to a mechanical open-close valve which is adapted to be inserted and to operate within each receiving fuel tank being refueled. Thus, the mechanical open-close valve is suitably shaped and sized to pass through a neck diameter of each receiving fuel tank being refueled.

In an embodiment, the mechanical open-close valve includes a buoyant body which is buoyant in liquid fuel, and which floats at or near the top of the level of liquid fuel in each receiving fuel tank. As the buoyant body rises with the level of fuel in a receiving fuel tank being refueled, the buoyant body actuates a mechanical open-close valve housed in an upper body.

In one illustrative embodiment, the buoyant body is vertically aligned with the upper body housing the mechanical open-close valve, and is adapted to actuate the mechanical open-close valve utilizing a vertical plunger. In use, as the buoyant body rises with the level of liquid fuel within a receiving fuel tank, the vertical plunger actuates the mechanical open-close valve to a closed position. When the level of liquid fuel within a receiving fuel tank subsequently lowers as fuel is used, the buoyant body also lowers until the mechanical open-close valve is once again reopened.

In another illustrative embodiment, the buoyant body is attached to the end of an arm which is rotatably joined to an upper body at an elbow joint. As the buoyant body rises with the liquid fuel in the fuel tank, the buoyant body bends the arm at the elbow joint to form a smaller angle between the arm and the upper body. The buoyant body is thus adapted to rotate about the elbow joint and to actuate a mechanical open-close valve to a closed position to shut off the flow of fuel when the buoyant body reaches a predetermined rotated position relative to the upper body.

In another embodiment, the buoyant body is adjustable to actuate the mechanical open-close valve to a closed position as the floating member reaches a predetermined level in the receiving fuel tank. This predetermined level may be at any level selected by a user, including any level less than a full tank.

In another embodiment, the system further comprises a controller which is adapted to monitor a flow meter on each fuel line, and to detect when a mechanical open-close valve has been actuated to shut off the flow of fuel to a receiving fuel tank. Upon detection that the flow of fuel to a receiving fuel tank has stopped, the system engages a solenoid safety valve.

Periodically, the controller disengages the solenoid safety valve to attempt to refuel a receiving fuel tank. If the controller detects that the mechanical open-close valve continues to remain closed, the controller engages the solenoid safety valve once more, and waits for a predetermined time period before disengaging the solenoid safety valve and attempting to refuel the receiving fuel tank once again.

If, upon disengaging the solenoid safety valve, the controller detects that the mechanical open-close valve is once again open, the controller initiates a supply of fuel to the fuel line in order to begin refueling the receiving fuel tank.

In an embodiment, as a safety feature, the controller limits the amount of time that a supply of fuel can be provided to any fuel line supplying a receiving fuel tank. Thus, even if the mechanical open-close valve in a receiving fuel tank remains open, the flow of fuel may be periodically shut off by the system for a scheduled time out. This allows the controller to recheck the status of the fuel line after the scheduled time out, until the next cycle.

In another embodiment, the controller may be adapted to schedule the status check of the fuel lines in succession, such that the system attempts refueling of each line successively. However, the system is also capable of supplying all fuel lines at the same time if all lines happen to be open.

Other features and advantages of the present invention will become apparent from the following detailed description and accompanying drawings. It should be understood, however, that the detailed description and specific examples are given by way of illustration and not limitation.

Many modifications and changes within the scope of the present invention may be made without departing from the spirit thereof, and the invention includes all such modifications.

### BRIEF DESCRIPTION OF THE DRAWINGS

FIG. 1 shows a perspective view of an illustrative system in accordance with an embodiment.

FIG. 2A shows a top plan view of the illustrative system of FIG. 1.

FIG. 2B shows a front plan view of the illustrative system of FIG. 1.

FIG. 2C shows a right side view of the illustrative system of FIG. 1.

FIG. 3 shows an illustrative schematic block diagram of a system in accordance with an embodiment.

FIGS. 4A and 4B show an illustrative mechanical open-close valve in accordance with an embodiment.

FIG. 4C and FIG. 4D shows another illustrative mechanical open-close valve in accordance with another embodiment.

FIG. 4E shows another illustrative mechanical open-close valve in accordance with another embodiment.

FIG. 4F shows a close-up perspective view of a portion of the valve assembly of FIGS. 4C and 4D.

FIGS. 4G and 4H show a top view and a front plan view of the valve assembly of FIG. 4F.

FIGS. 5A and 5B show an illustrative mechanical open-close valve with a rotating arm in accordance with another embodiment.

FIG. 5C shows a perspective view of an illustrative mechanical open-close valve with a rotating arm in accordance with another embodiment.

FIG. 5D shows a plan view of the mechanical open-close valve of FIG. 5C.

FIG. 6 shows a schematic block diagram of a generic computing device in accordance with an embodiment.

### DETAILED DESCRIPTION

As noted above, the present disclosure describes a refueling system and method for simultaneously refueling the fuel tanks of multiple pieces of machinery in the field. Various illustrative embodiments will now be described with reference to the drawings.

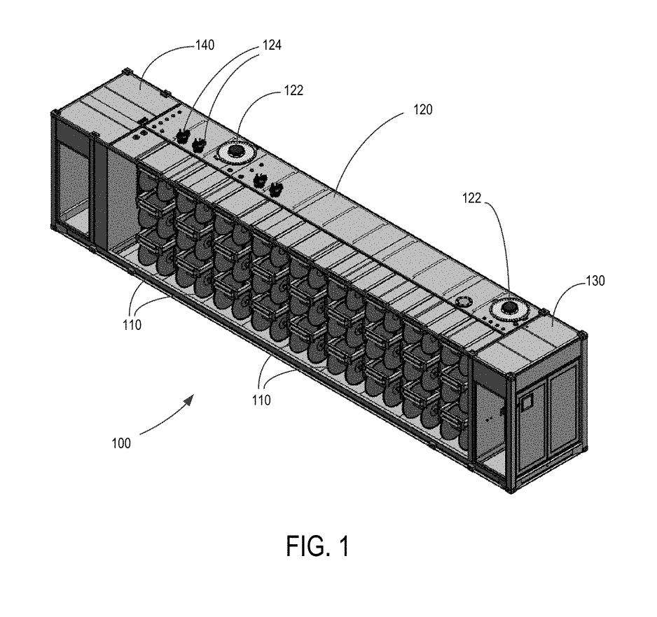

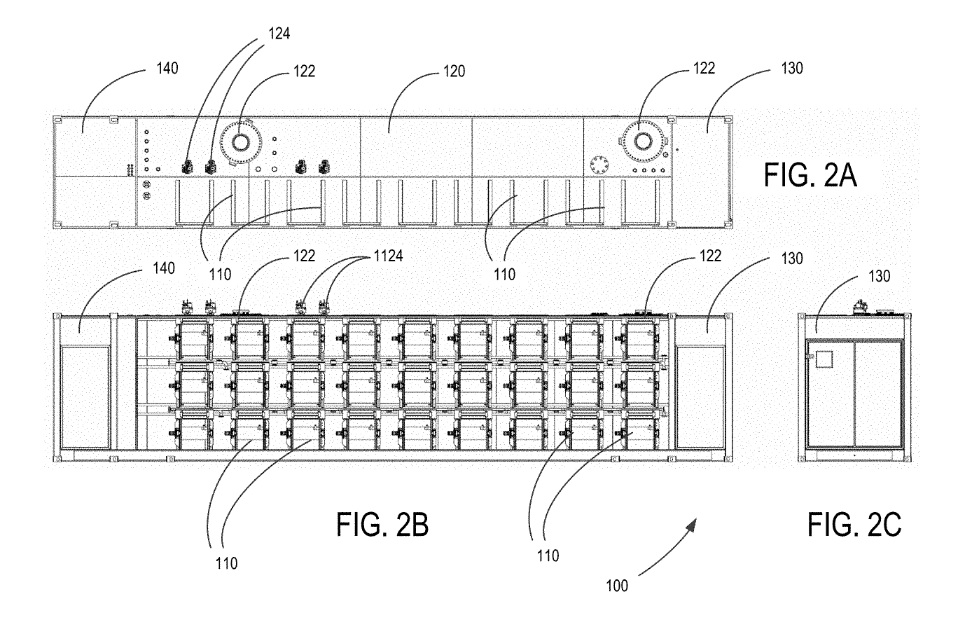

First referring to FIG. 1, shown is a perspective view of an illustrative system in accordance with an embodiment. Corresponding plan views are shown in FIGS. 2A-2C. As shown in this illustrative example, the system comprises a mobile tanker 100 with at least one fuel supply tank 120 configured to connect and supply a plurality of refueling hoses 110. The fuel supply tank 120 may be accessed via hatches or man holes 122 for servicing, and may be filled via filling valve connections 124 at a fuel depot, before the mobile tanker 100 is transported to a work site.

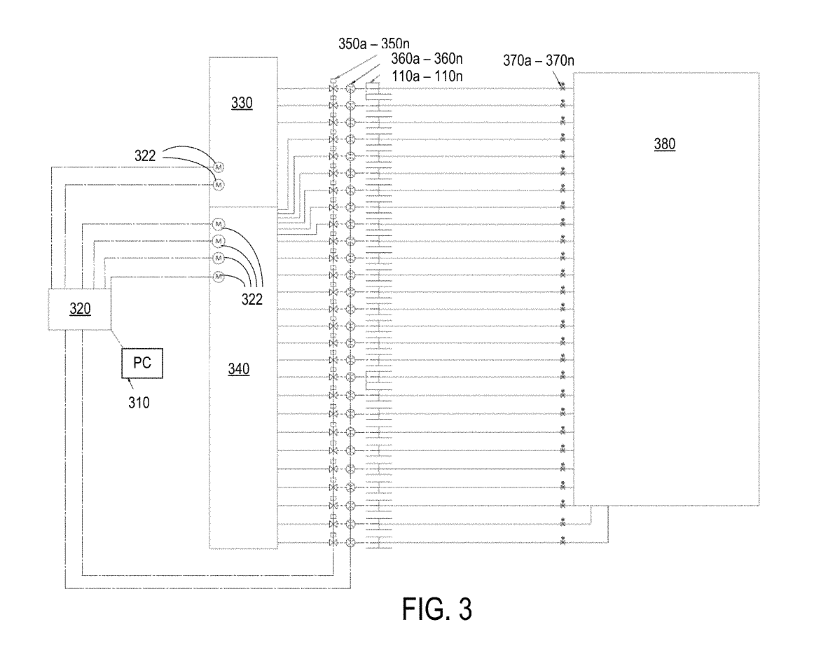

Still referring to FIG. 1, and FIGS. 2A-2C, in an embodiment, the system further includes enclosures or cabinets 130, 140 at either end of the mobile tanker 100, which cabinets 130, 140 may enclose electrical power generators, batteries, and controllers (see controller 320 in FIG. 3, as described below) for controlling various components of the mobile tanker 100. The controllers are powered by the batteries which are periodically or continually recharged. Other electrical components in the system are also powered by the batteries, such as electrical solenoids for opening and closing safety valves, as described in more detail below. The cabinets 130, 140 may be heated or cooled, and humidified or dehumidified to maintain suitable operating conditions for the modules housed therein.

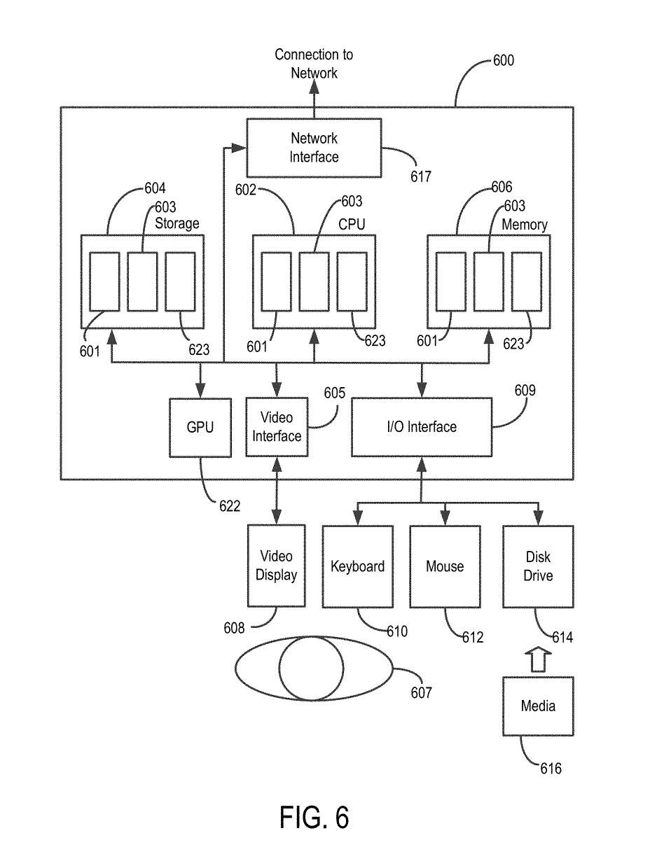

Now referring to FIG. 3, shown is a schematic block diagram of the system in accordance with an illustrative embodiment. As shown, the system includes a computer device 310 which, as shown in the block, may be a generic computer device (see computer device 600 in FIG. 6). The computer device 310 may be accessed directly by an onsite operator, or may be adapted to wirelessly communicate with another remote computing device in order to be controlled remotely.

Still referring to FIG. 3, the computer device 310 is operatively connected to a controller 320, which is in turn connected to a plurality of fuel supply lines arranged in banks 330 and 340. The controller 320 also controls a plurality of turbine pumps 322 for pumping fuel to the plurality of fuel supply lines.

In an embodiment, each fuel supply line is connected to a solenoid safety valve 350a-350n, and then to a flow meter 360a-360n, before connecting to an upstream end of a refueling hose 110. Each refueling hose 110 may be wound on a reel for storage, and pulled out for dispensing fuel to a receiving fuel tank at a work site 380.

In another embodiment, the system further comprises a controller which is adapted to monitor a flow meter 360a-360n on each fuel line, and to detect when a mechanical open-close valve has been actuated to shut off the flow of fuel to a receiving fuel tank. Upon detection that the flow of fuel to a receiving fuel tank has stopped, the system engages a corresponding solenoid safety valve 350a-350n.

In an embodiment, periodically, the controller 320 disengages an engaged solenoid safety valve 350a-350n to attempt to refuel a corresponding receiving fuel tank. If the controller 320 detects that the mechanical open-close valve on a fuel line continues to remain closed, indicating that the fuel level remains sufficiently high, the controller 320 engages the solenoid safety valve 350a-350n once more, and waits for a predetermined time period before disengaging the solenoid safety valve 350a-350n once again, and attempting to refuel the corresponding receiving fuel tank.

If, upon disengaging the solenoid safety valve 350a-350n, the controller 320 detects that the mechanical open-close valve is once again open, indicating that the level of fuel in the receiving fuel tank has been lowered through use, the controller 320 initiates a supply of fuel to the fuel line in order to begin refueling the receiving fuel tank.

In an embodiment, as a safety feature, the controller 320 limits the amount of time that a supply of fuel can be provided to any fuel line supplying a receiving fuel tank. Thus, even if the mechanical open-close valve in a particular receiving fuel tank remains open, the flow of fuel may be periodically shut off by the controller 320 for a scheduled time out. This allows the controller 320 to recheck the status of the fuel line after the scheduled time out, until the next cycle.

In another embodiment, the controller 320 may be adapted to schedule the status check of the fuel lines in succession, such that the system attempts refueling of each line successively. However, the system is also capable of supplying all fuel lines at the same time if all fuel lines happen to be open at any given time.

Still referring to FIG. 3, a downstream end of each refueling hose 110 is connected to a mechanical open-close valve 370a-370n. The mechanical open-close valve 370a-370n is adapted to be inserted and to operate within each receiving fuel tank being refueled in the work site 380. As will be described in further detail below, the mechanical open-close valve is suitably shaped and sized to pass through the neck diameter of each receiving fuel tank being refueled.

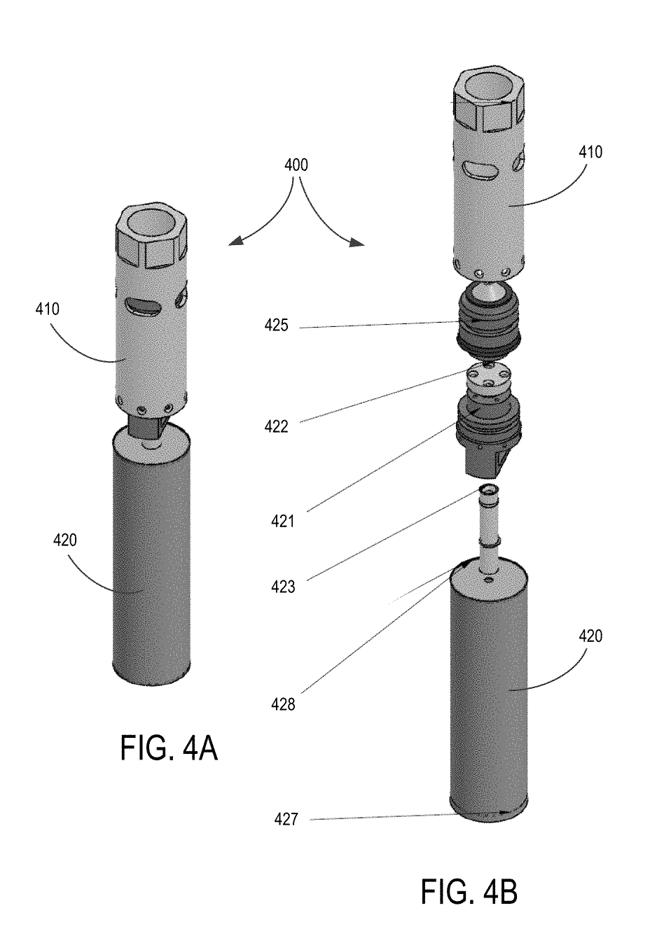

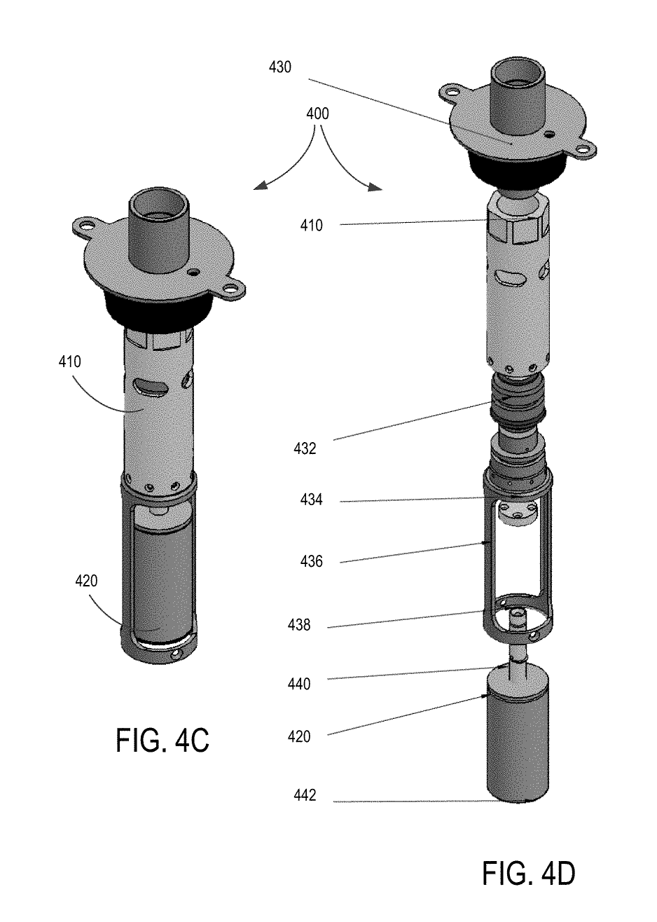

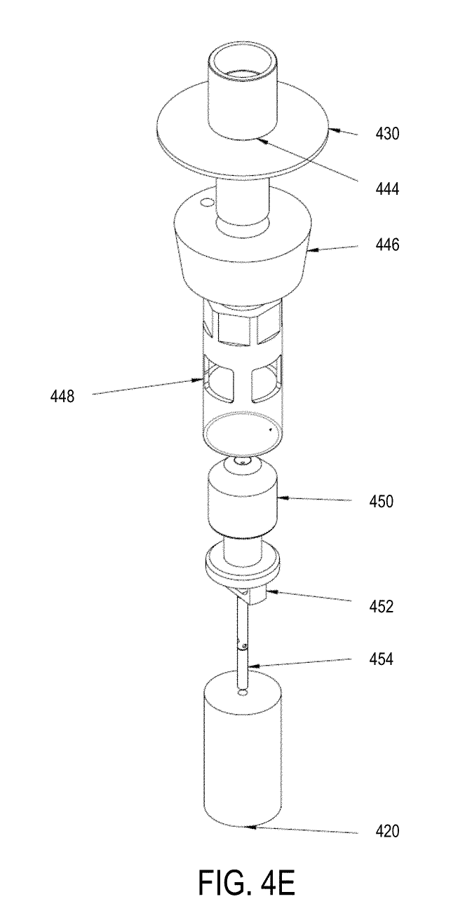

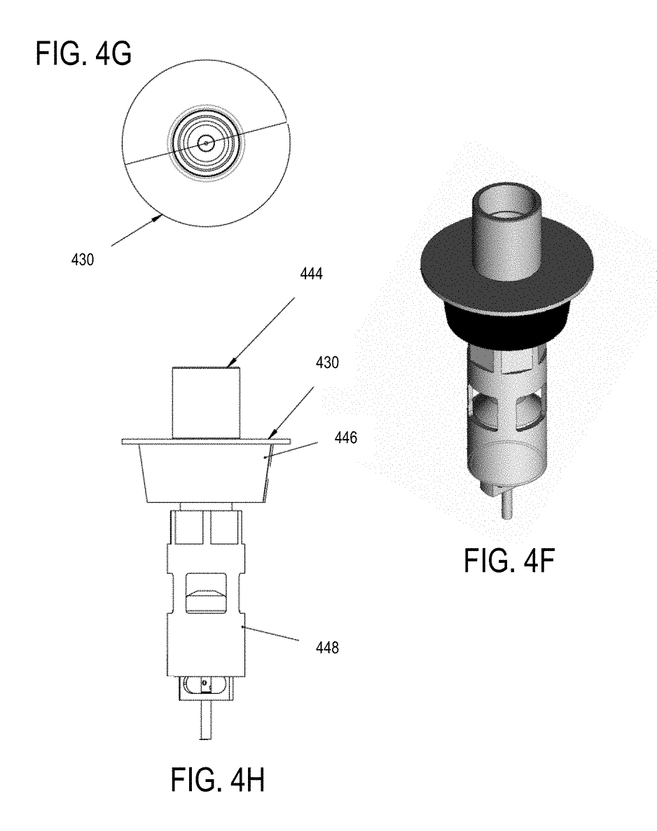

Now referring to FIGS. 4A and 4B, shown is an illustrative mechanical open-close valve 400 in accordance with an embodiment. In this illustrative example, the mechanical open-close valve 400 includes a buoyant body 420 which is buoyant in liquid fuel due to a liquid and air tight lower end cap 427 and upper end cap 428. The buoyant body 420 is adapted to float at or near the top of the level of liquid fuel in each receiving fuel tank. As the buoyant body 420 rises with the level of fuel in a receiving fuel tank being refueled due to its buoyancy, the buoyant body 420 actuates a mechanical open-close valve housed in an upper body 410 into a closed position. Conversely, as the buoyant body 420 lowers with the level of fuel in the receiving fuel tank as the fuel is used, the mechanical open-close valve is reopened.

With reference to FIG. 4B, in an embodiment, the buoyant body 420 is vertically aligned with the upper body 410 housing the open-close valve, comprising a float plunger 425 adapted to open and close an aperture. An equalization body 421 having a piston stopper 422 is situated below the float plunger 425, and above the buoyant body 420 which has an extending piston rod 423. The piston rod 423 presses up against the equalization body 421 and actuates the mechanical open-close valve (i.e. the float plunger 425) to close an aperture which allows fuel to flow through the upper body 410. In other words, the mechanical open-close valve is adapted to be mechanically actuated by the buoyant body 420, either into a closed position or an open position, as the buoyant body 420 responds to changing fuel levels within the receiving fuel tank.

Now referring to FIG. 4C and FIG. 4D, shown is an illustrative mechanical open-close valve in accordance with another embodiment. In FIG. 4C, an upper body 410 is coupled to a buoyant body 420. As shown in FIG. 4D, a locator 430 near the top of the assembly positions the upper body 310 and buoyant body 420 within a fuel tank to be refueled. A float plunger 432 is shown below the upper body 410, but is normally received within the upper body 410, as shown in FIG. 4C. Below the float plunger 432 is a piston stopper 434, which normally abuts the upper body 410 as shown in FIG. 4C.

Still referring to FIGS. 4C and 4D, a guard 436 receives and guards the buoyant body 420, as illustrated in FIG. 4C. Piston rod 438 couples the buoyant body 420 to the upper body 410, while the guard 436 keeps the buoyant body 420 in position. A first float end cap 440 couples the piston rod 438 and seals a first end of the buoyant body 420. A second float end cap 442 seals a second end of the buoyant body.

Now referring to FIG. 4E, shown is another illustrative embodiment in which a swivel socket 444 on the locator 430 is adapted to receive a hose connector or joint in use. Locator float 446 is adapted to receive socket 444. An upper body 448 is adapted to receive float stopper 450 and float end stopper 452. A piston rod or shaft 454 is coupled to buoyant float 420.

FIG. 4F shows a close-up perspective view of an upper portion of the valve assembly of FIGS. 4C and 4D, with FIGS. 4G and 4H showing a corresponding top view and a corresponding front plan view, respectively, of the valve assembly of FIG. 4F.

In each of the embodiments illustrated in FIG. 4A, FIG. 4B and FIG. 4C, buoyant float 420 actuates the mechanical open-close valve to either start or stop the flow of fuel through the valve as the buoyant body 420 responds to changing fuel levels within the receiving fuel tank.

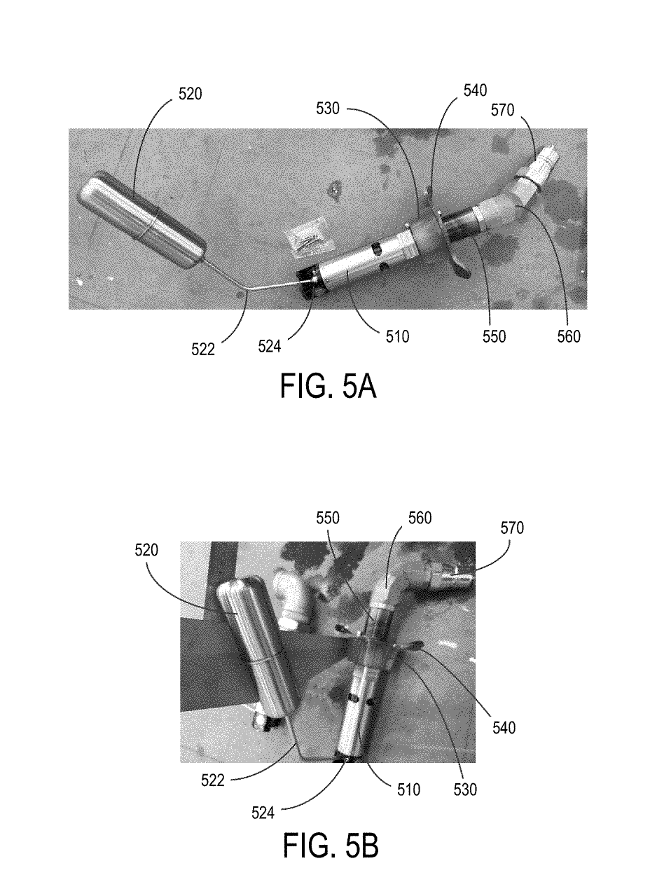

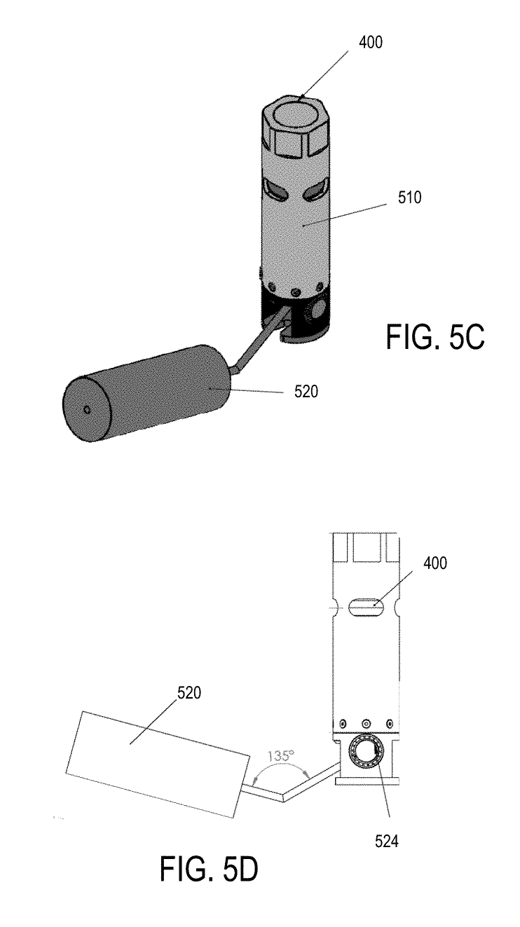

Now referring to FIGS. 5A and 5B, shown is another illustrative embodiment of a mechanical open-close valve 500. In this embodiment, a buoyant body 520 is attached to the end of an arm 522 which is rotatably joined to an upper body 510 at an elbow joint 524. As the buoyant body 520 rises with the level of liquid fuel in a receiving fuel tank, the buoyant body 520 bends the arm 522 at the elbow joint 524 to form a smaller angle between the arm 524 and the upper body 510. The buoyant body 520 is thus adapted to rotate about the elbow joint 524 and to actuate a mechanical open-close valve housed in the upper body 510 to a closed position, in order to shut off the flow of fuel when the buoyant body 520 reaches a sufficiently high rotated position relative to the upper body 510. This shut off point may be set at any suitable level selected by a user, including any fuel level less than a full tank.

Still referring to FIGS. 5A and 5B, in an embodiment, each mechanical open-close valve 500 is topped by a positioning member 530 and flanged tabs 540 adapted to extend across the neck opening of a receiving fuel tank. The tabs 540 may be provided with an aperture for hooking a bungee cord, or other means for securing the positioning member 530 in position. Immediately above the tabs 540 is a short column 550 connected via a corner joint 560 to another threaded column 570 for receiving a downstream end of a refueling hose 110 as described earlier.

FIG. 5C shows a perspective view of an illustrative mechanical open-close valve with a rotating arm in accordance with another embodiment, and FIG. 5D shows a corresponding plan view. In operation, the mechanical open-close valve is adapted to be mechanically actuated by the buoyant body 520, either into a closed position or an open position, as the buoyant body 520 responds to changing fuel levels within the receiving fuel tank and reaches a sufficiently high or sufficiently low rotated position relative to the upper body 510.

Now referring to FIG. 6, a suitably configured generic computer device 600, and associated communications networks, devices, software and firmware may provide a platform for enabling one or more embodiments as described above. By way of example, FIG. 6 shows a generic computer device 600 that may include a central processing unit (“CPU”) 602 connected to a storage unit 604 and to a random access memory 606. The CPU 602 may process an operating system 601, application program 603, and data 623. The operating system 601, application program 603, and data 623 may be stored in storage unit 604 and loaded into memory 606, as may be required. Computer device 600 may further include a graphics processing unit (GPU) 622 which is operatively connected to CPU 602 and to memory 606 to offload intensive image processing calculations from CPU 602 and run these calculations in parallel with CPU 602. An operator 607 may interact with the computer device 600 using a video display 608 connected by a video interface 605, and various input/output devices such as a keyboard 610, mouse 612, and disk drive or solid state drive 614 connected by an I/O interface 609. In known manner, the mouse 612 may be configured to control movement of a cursor in the video display 608, and to operate various graphical user interface (GUI) controls appearing in the video display 608 with a mouse button. The disk drive or solid state drive 614 may be configured to accept computer readable media 616. The computer device 600 may form part of a network via a network interface 611, allowing the computer device 600 to communicate through wired or wireless communications with other suitably configured data processing systems (not shown).

As noted earlier, the generic computer device 600 may also be configured to communicate wirelessly with a remote computer device (not shown), such that the system may be controlled and operated remotely. It will be appreciated that the present description does not limit the size or form factor of the computing device on which the present system and method may be embodied.

With reference to FIG. 6, and referring back to FIG. 3, in an embodiment, the controller 320 controls is adapted to monitor the flow meters 360a-360n on each fuel line, and to detect when a corresponding mechanical open-close valve 400, 500 has been actuated to shut off the flow of fuel to a receiving fuel tank. Upon detection that the flow of fuel has stopped based on observing no flow through one or more of the flow meters 360a-360n, the system engages a solenoid safety valve 350a-350n to close the fuel line.

Periodically, the controller 320 reopens the solenoid safety valve to attempt to refuel. If the controller 320 detects that the mechanical open-close valve 400, 500 continues to remain closed (i.e. no flow is observed through the corresponding flow meters 360a-360n), the controller 320 recloses the solenoid safety valve 350a-350n for that fuel supply line, and waits for a predetermined time period before attempting to refuel again.

If, upon reopening the solenoid safety valve 350a-350n for a given fuel supply line, the controller 320 detects that the corresponding mechanical open-close valve 400, 500 is once again open, the controller 320 supplies fuel to the reopened fuel line in order to begin refueling the receiving fuel tank.

In an embodiment, as a safety feature, the controller 320 limits the amount of time that a supply of fuel can be provided to any fuel line by periodically shutting off the flow of fuel, even if the receiving fuel tank is not full. This allows the controller 320 to recheck the status of the fuel line after a scheduled time out, until the next cycle.

In an embodiment, the controller 320 staggers the scheduled status check of the fuel lines, such that the system attempts refueling of only one or several fuel lines at a time. This allows the system to better regulate and maintain pump pressure in the system, in order to supply fuel to the fuel lines which are open at any time.

Thus, in an aspect, there is provided a refueling system, comprising: a fuel supply tank; a controller for supplying fuel from the fuel supply tank to a plurality of fuel lines; a plurality of refueling hoses, each refueling hose connected to one of the plurality of fuel lines at an upstream end; and a plurality of mechanical open-close valves, each mechanical open-close valve terminating one of the plurality of refueling hoses at a downstream end, and having a buoyant body adapted to mechanically actuate the mechanical open-close valve.

In an embodiment, the plurality of mechanical open-close valves are adapted to pass through a respective inner neck diameter of a receiving fuel tank being refueled.

In another embodiment, the buoyant body is buoyant in liquid fuel in the receiving fuel tank.

In another embodiment, at least one of the mechanical open-close valves is adapted to be actuated as the buoyant body rises or lowers relative to an upper body of the mechanical open-close valves in dependence on the level of liquid fuel in the receiving fuel tank.

In another embodiment, the buoyant body in use is vertically aligned with an upper body housing the mechanical open-close valve, and the system is adapted to actuate the mechanical open-close valve utilizing a vertically oriented plunger.

In another embodiment, the buoyant body is attached to an arm which is rotatably joined to an upper body housing the mechanical open-close valve, and is adapted to actuate the mechanical open-close valve utilizing rotation at the elbow joint to a predefined angle.

In another embodiment, the position of the buoyant body is adjustable relative to an upper body housing the mechanical open-close valve to calibrate when the mechanical open-close valve is actuated.

In another embodiment, the refueling system further comprises a controller which is adapted to monitor a flow meter on each fuel line, and to detect when a mechanical open-close valve has been actuated to shut off the flow of fuel to a receiving fuel tank.

In another embodiment, the refueling system further comprises a safety valve adapted to engage upon detection that flow of fuel to a receiving fuel tank has stopped.

In another embodiment, the refueling system is further adapted to periodically disengage the safety valve to attempt to refuel a receiving fuel tank, and upon detection that the corresponding mechanical open-close valve remains closed, reengage the safety valve.

In another embodiment, the refueling system is further adapted to periodically disengage the safety valve to attempt to refuel a receiving fuel tank, and upon detection that the corresponding mechanical open-close valve is open, continuing the refueling.

In another embodiment, the refueling system is further adapted to periodically stop one or more fuel lines supplying a receiving fuel tank to confirm the status of the one or more fuel lines.

In another aspect, there is provided a method of refueling a plurality of receiving fuel tanks, comprising: providing a fuel supply tank; providing a controller for supplying fuel from the fuel supply tank to a plurality of fuel lines; providing a plurality of refueling hoses, each refueling hose connected to one of the plurality of fuel lines at an upstream end; and mechanically actuating a plurality of mechanical open-close valves having a buoyant body, each mechanical open-close valve terminating one of the plurality of refueling hoses at a downstream end.

In an embodiment, the plurality of mechanical open-close valves are adapted to pass through a respective inner neck diameter of a receiving fuel tank being refueled.

In another embodiment, at least one of the buoyant body is buoyant in liquid fuel in the receiving fuel tank.

In another embodiment, the method further comprises actuating at least one of the mechanical open-close valves as the buoyant body rises or lowers relative to an upper body of the mechanical open-close valves in dependence on the level of liquid fuel in the receiving fuel tank.

In another embodiment, the method further comprises actuating at least one of the mechanical open-close valves utilizing a vertical plunger coupled to a buoyant body which is vertically aligned with an upper body housing the mechanical open-close valve.

In another embodiment, the method further comprises actuating at least one of the mechanical open-close valves utilizing a buoyant body is attached to an arm which is rotatably joined to an upper body housing the mechanical open-close valve.

In another embodiment, the method further comprises adjusting the position of the buoyant body relative to an upper body housing the mechanical open-close valve to calibrate when the mechanical open-close valve is actuated.

In another embodiment, the method further comprises monitoring a flow meter on each fuel line to detect actuation of a mechanical open-close valve.

In another embodiment, the method further comprises engaging a safety valve upon detection that flow of fuel to a receiving fuel tank has stopped.

In another embodiment, the method further comprises periodically disengaging the safety valve to attempt to refuel a receiving fuel tank, and upon detection that the corresponding mechanical open-close valve remains closed, reengaging the safety valve.

In another embodiment, the method further comprises periodically disengaging the safety valve to attempt to refuel a receiving fuel tank, and upon detection that the corresponding mechanical open-close valve is open, continuing the refueling.

In another embodiment, the method further comprises periodically stopping one or more fuel lines supplying a receiving fuel tank to confirm the status of the one or more fuel lines.

In another aspect, there is provided an apparatus for controlling the flow of fuel into a receiving fuel tank, comprising: a connector for connection to a downstream end of a refueling hose; a mechanical open-close valve adapted to be passed through a respective inner neck diameter of a receiving fuel tank being refueled; and a buoyant body buoyant in liquid fuel, and adapted to mechanically actuate the mechanical open-close valve in dependence upon the level of liquid fuel in the receiving fuel tank.

While illustrative embodiments have been described above by way of example, it will be appreciated that various changes and modifications may be made without departing from the scope of the system and method, which is defined by the following claims.

1. A refueling system, comprising:
a fuel supply tank;
a controller for supplying fuel from the fuel supply tank to a plurality of fuel lines;
a plurality of refueling hoses, each refueling hose connected to one of the plurality of fuel lines at an upstream end; and
a plurality of mechanical open-close valves, each mechanical open-close valve terminating one of the plurality of refueling hoses at a downstream end, and having a buoyant body adapted to mechanically actuate the mechanical open-close valve.

2. The refueling system of claim 1, wherein the plurality of mechanical open-close valves are adapted to pass through a respective inner neck diameter of a receiving fuel tank being refueled.

3. The refueling system of claim 2, wherein the buoyant body is buoyant in liquid fuel in the receiving fuel tank.

4. The refueling system of claim 3, wherein at least one of the mechanical open-close valves is adapted to be actuated as the buoyant body rises or lowers relative to an upper body of the mechanical open-close valves in dependence on the level of liquid fuel in the receiving fuel tank.

5. The refueling system of claim 3, wherein the buoyant body in use is vertically aligned with an upper body housing the mechanical open-close valve, and the system is adapted to actuate the mechanical open-close valve utilizing a vertically oriented plunger.

6. The refueling system of claim 3, wherein the buoyant body is attached to an arm which is rotatably joined to an upper body housing the mechanical open-close valve, and is adapted to actuate the mechanical open-close valve utilizing rotation at the elbow joint to a predefined angle.

7. The refueling system of claim 3, wherein the position of the buoyant body is adjustable relative to an upper body housing the mechanical open-close valve to calibrate when the mechanical open-close valve is actuated.

8. The refueling system of claim 1, further comprising a controller which is adapted to monitor a flow meter on each fuel line, and to detect when a mechanical open-close valve has been actuated to shut off the flow of fuel to a receiving fuel tank.

9. The refueling system of claim 8, further comprising a safety valve adapted to engage upon detection that flow of fuel to a receiving fuel tank has stopped.

10. The refueling system of claim 9, wherein the system is further adapted to periodically disengage the safety valve to attempt to refuel a receiving fuel tank, and upon detection that the corresponding mechanical open-close valve remains closed, reengage the safety valve.

11. The refueling system of claim 9, wherein the system is further adapted to periodically disengage the safety valve to attempt to refuel a receiving fuel tank, and upon detection that the corresponding mechanical open-close valve is open, continuing the refueling.

12. The refueling system of claim 1, wherein the system is further adapted to periodically stop one or more fuel lines supplying a receiving fuel tank to confirm the status of the one or more fuel lines.

13. A method of refueling a plurality of receiving fuel tanks, comprising:
providing a fuel supply tank;
providing a controller for supplying fuel from the fuel supply tank to a plurality of fuel lines;
providing a plurality of refueling hoses, each refueling hose connected to one of the plurality of fuel lines at an upstream end; and
mechanically actuating a plurality of mechanical open-close valves having a buoyant body, each mechanical open-close valve terminating one of the plurality of refueling hoses at a downstream end.

14. The method of claim 13, wherein the plurality of mechanical open-close valves are adapted to pass through a respective inner neck diameter of a receiving fuel tank being refueled.

15. The method of claim 14, wherein at least one of the buoyant body is buoyant in liquid fuel in the receiving fuel tank.

16. The method of claim 15, further comprising actuating at least one of the mechanical open-close valves as the buoyant body rises or lowers relative to an upper body of the mechanical open-close valves in dependence on the level of liquid fuel in the receiving fuel tank.

17. The method of claim 15, further comprising actuating at least one of the mechanical open-close valves utilizing a vertical plunger coupled to a buoyant body which is vertically aligned with an upper body housing the mechanical open-close valve.

18. The method of claim 15, further comprising actuating at least one of the mechanical open-close valves utilizing a buoyant body is attached to an arm which is rotatably joined to an upper body housing the mechanical open-close valve.

19. The method of claim 15, further comprising adjusting the position of the buoyant body relative to an upper body housing the mechanical open-close valve to calibrate when the mechanical open-close valve is actuated.

20. The method of claim 11, further comprising monitoring a flow meter on each fuel line to detect actuation of a mechanical open-close valve.

21. The method of claim 20, further comprising engaging a safety valve upon detection that flow of fuel to a receiving fuel tank has stopped.

22. The method of claim 21, further comprising periodically disengaging the safety valve to attempt to refuel a receiving fuel tank, and upon detection that the corresponding mechanical open-close valve remains closed, reengaging the safety valve.

23. The method of claim 21, further comprising periodically disengaging the safety valve to attempt to refuel a receiving fuel tank, and upon detection that the corresponding mechanical open-close valve is open, continuing the refueling.

24. The method of claim 1, further comprising periodically stopping one or more fuel lines supplying a receiving fuel tank to confirm the status of the one or more fuel lines.

25. An apparatus for controlling the flow of fuel into a receiving fuel tank, comprising:
a connector for connection to a downstream end of a refueling hose;
a mechanical open-close valve adapted to be passed through a respective inner neck diameter of a receiving fuel tank being refueled; and
a buoyant body buoyant in liquid fuel, and adapted to mechanically actuate the mechanical open-close valve in dependence upon the level of liquid fuel in the receiving fuel tank.
